(19) United States
(12) Patent Application Publication
(10) Pub. No.: US 2010/0329714 A1
(43) Pub. Date: Dec. 30, 2010

(54) IMAGE FORMING APPARATUS

(75) Inventors: Shinichi Tsukamura, Uenohara-shi (JP); Keiki Katsumata, Tokyo (JP)

Correspondence Address: CANTOR COLBURN LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/819,842

(22) Filed: Jun. 21, 2010

(30) Foreign Application Priority Data
Jun. 24, 2009 (JP) 2009-149686

(51) Int. Cl. G03G 15/16; G03G 21/00

(52) U.S. Cl. 399/66; 399/129

(57) ABSTRACT

An image forming apparatus including: a photoreceptor; a charging section to charge the photoreceptor; a developing section to develop a latent image; a transfer section to transfer the developed image to a transfer sheet using a contact transfer method; a cleaning section to remove a remaining toner on the photoreceptor; a control section that performs control so that a toner image is formed in an image forming region, the toner image is transferred to the transfer sheet, and a toner image is formed which is not transferred to the transfer sheet in a region between image forming regions on the photoreceptor; and a charge elimination section provided between the transfer section and the cleaning section; wherein the control section controls polarities of electric current applied to the transfer section and the charge elimination section so that the polarities differ between the image forming region and the region between images.

This application is based on Japanese Patent Application No. 2009-149686 filed on Jun. 24, 2009 in Japanese Patent Office, the entire content of which is hereby incorporated by reference.

### BACKGROUND

1. Field of the Invention

The present invention relates to an image forming apparatus, and in particular to an electrophotographic image forming apparatus of a contact transfer method.

2. Description of Related Art

An electrophotographic image forming apparatus forms an image on a sheet of paper in such a manner that a photoreceptor is uniformly charged, onto which an electrostatic latent image is formed by an imagewise exposure, and then, the above electrostatic latent image is developed with toner, and after that, the resulting toner image is transferred to a sheet of paper and the image is fixed. The photoreceptor, after the toner image formed thereon having been transferred, is used to the next image formation, after any toner remaining on the photoreceptor is removed by a cleaning device.

Many of the recent electrophotographic image forming apparatuses are based on a system in which an electrostatic latent image formed on a negatively charged photoreceptor is developed by a reversal development method (a development with negatively charged toner). In this case, an image transfer is, in general, carried out by applying a positive charge, via a positive transfer charger, to the back of a sheet of paper to draw negatively charged toner located on the photoreceptor toward the sheet of paper. Further, it has also been carried out to enhance separability by neutralizing charges, after the transfer charger, on the back of the sheet of paper with a separation charger having a reverse polarity or with AC being applied.

In such a constitution, since the surface potential of the photoreceptor after transfer and the charge amount of the residual toner have been decreased, the removal of the residual toner by a cleaning device can be relatively readily performed. However, in order to further facilitate the cleaning performance, there exists a technology for further neutralizing charges of the residual toner via a charger between a transfer step and a cleaning step.

Japanese Patent Application Publication No. H8-137356 has disclosed a technology similar to the above charge neutralization of the above residual toner. According to the technology disclosed in the Japanese Patent Application Publication No. H8-137356, a problem, in which, in the normal development method, charges on toner remaining at a tip of cleaning blade degrades the photoreceptor to generate white lines on an image, is solved by removing the charges on toner by applying charges having a reverse polarity from the charges on toner via a charger arranged in front of the cleaning device.

In addition, Japanese Patent Application Publication No. H11-15343 has disclosed a technology, which applies, before the cleaning step, different charges between an image forming region and a region between mages, in order to solve a memory (a phenomenon in which, even in a major electrification, a charge amount on a photoreceptor becomes uneven due to a difference of a remaining charge amount on a photoreceptor), which becomes a problem when a constitution, in which a transfer charge is not switched off even in a region between images to carry out a high-speed continuous image formation, is adopted.

On the other hand, separately from a transfer separation method using a charger, there also exists an image forming apparatus adopting a contact transfer method using a transfer roller or a transfer belt. Since, in the contact transfer method, a sheet of paper is allowed to be in close contact with a photoreceptor by the transfer roller or the transfer belt, stable transfer properties can be obtained over the whole area of a sheet of paper. Japanese Patent Application Publication No. 2004-94037 discloses such a contact transfer method, and discloses a technology, aiming to solve problems of a white spot-shaped image defect caused by local insulation breakdown due to the uneven resistance distribution of the transfer materials, and back stains of transfer materials, which technology arranges an insulating layer having the volume resistivity of 1×10⁷ Ωcm or more on the surface layer of the transfer roller or transfer belt, and further, applies an elimination bias, which differs from a transfer bias, with a frequency of about once in 100 to 1,000 times of the image formation.

However, in the contact transfer method, electric charges are not removed from a photoreceptor like the contact transfer method using a charger. Therefore, electric adhesion force of the residual toner on the photoreceptor is strong, so that a cleaning by a cleaning device can sometimes not sufficiently be achieved. In particular, in case where a toner image is formed in a region between images, the toner image is not transferred onto a sheet of paper, so that the toner strongly adheres to the photoreceptor, whereby the cleaning properties become insufficient or a heavy workload is imposed on the cleaning device.

An example of a toner image in a region between images is a technology in which a development density is stabilized by forming a patch of toner image in a region between images, and detecting an amount of reflection light from the above patch of toner image, which amount is then given feedback to a development parameter. As other examples, in such cases as where images with low toner coverage continue, the toner deteriorates, since a toner density in a development apparatus, in which a prescribed density is set, increases, or the residence time of toner in a development apparatus becomes longer, to result in an image quality being likely to be negatively affected. In order to solve the problem, in case where images with low toner coverage continue, there exists a technology to remove the residual toner by forming a toner belt unrelated to the image in a region between images. The above toner belt is removed by a cleaning section.

Though such a toner image in a region between images is a necessary technology to obtain an excellent image, the technology imposes a heavy workload on the cleaning device, as described above. When poor cleaning occurs at a cleaning device, the residual toner on the photoreceptor causes defects such as a stained image and a partial loss of image.

It is one of the objects of the present invention to form a toner image also in a region between images, which region is located between image forming regions, and at the same time, in an image forming apparatus conducting an image transfer by a contact transfer method, to reduce the charge amount of the above toner image, so that a cleaning of the residual toner is carried out successfully via a cleaning section.

### SUMMARY

To achieve at least one of the above mentioned objects, an image forming apparatus reflecting one aspect of the present invention comprises: a photoreceptor; a charging section to charge the photoreceptor; a developing section to develop a latent image formed on the photoreceptor; a transfer section to transfer the developed image to a transfer sheet using a contact transfer method; a cleaning section to remove a remaining toner on the photoreceptor; a control section that performs control so that a toner image is formed in an image forming region, the toner image is transferred to the transfer sheet, and a toner image is formed which is not transferred to the transfer sheet in a region between image forming regions on the photoreceptor; and a charge elimination section provided between the transfer section and the cleaning section; wherein the control section controls polarities of electric current applied to the transfer section and the charge elimination section so that the polarities differ between the image forming region and the region between images.

### BRIEF DESCRIPTION OF THE DRAWINGS

FIG. 1 is a cross section of the main part of the image forming apparatus relating to the present invention.

FIG. 2 is a timing chart for controlling polarity switching between the transfer belt and the pre-cleaning charger relating to the present invention.

FIG. 3 is a routine of charging a transfer belt 6 at a transfer section.

FIG. 4 is a routine of charging a photoreceptor drum 1 at a charging section for a blade cleaning.

### DESCRIPTION OF THE PREFERRED EMBODIMENTS

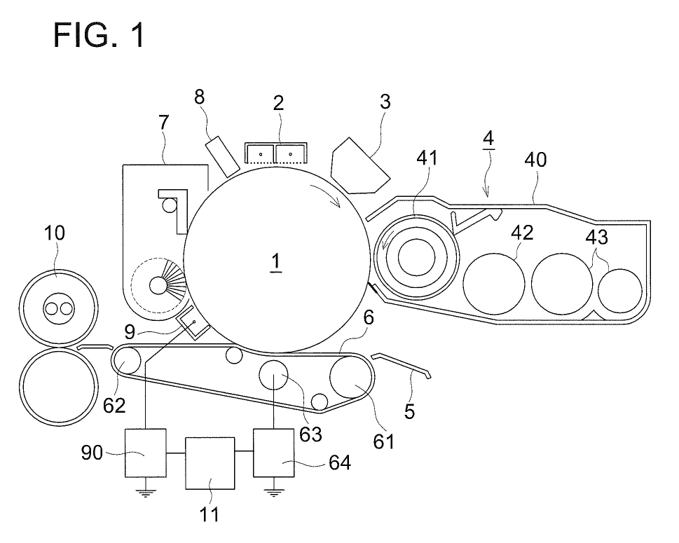

Hereinafter, the present invention will be described with reference to drawings. FIG. 1 is a cross section of the main part of the image forming apparatus, in which the present invention is carried out.

In FIG. 1, the numeral 1 is a photoreceptor drum as an image bearing body comprising: along the rotating direction of the photoreceptor drum 1, an electric charger 2; an image writing device 3 using an LED light source; a developing device 4 with a two-component developing system; a transfer guide 5 guiding a transfer sheet to a transfer region; a transfer belt 6 transferring a toner image formed on the photoreceptor drum 1 to a transfer sheet; a cleaning device 7 cleaning the photoreceptor drum 1 using both a brush and a blade; and an optical eraser 8 removing charges by irradiating erasing light to the photoreceptor drum 1. A pre-cleaning charger 9 as a pre-charge elimination section is arranged between the transfer belt 6 and the cleaning device 7. In the downstream of the transfer belt 6, a fixing device 10 is arranged to fix a toner image on the transfer sheet.

The developing device 4 has a developing sleeve 41 at an opening of its housing 40, and in the back of the developing sleeve 41 (in the right direction of the figure), there are arranged a developer conveying member 42 conveying developers (toner and carrier) to the developing sleeve 41, and an stirring member 43 stirring toner and carrier.

The transfer belt 6 is stretched and supported between two supporting rollers 61 and 62, and is pressure contacted against the photoreceptor drum 1 by a backup roller 63 arranged inside the transfer belt 6. The transfer belt 6 is composed of a two-layered structure of a semiconducting belt substrate and an insulating layer, arranged as a surface layer, having the volume resistivity of 1×10⁷ Ωcm or more. As the belt substrate, usable are, for example, a rubber substrate such as a chloroprene, and as the insulating layer, usable are, for example, a tetrafluoroethylene-perfluoro-alkylvinylether copolymer resin (PFA).

To the backup roller 63, a constant-current power supply 64 is connected, and an applying timing and an amount of current are controlled by a controlling means 11.

The pre-cleaning charger 9 is a corotron type charger, to which electrodes a constant-current power supply 90 is connected, and an applying timing and an amount of current are controlled by the controlling means 11. The controlling means 11, in addition to applying a current to the transfer belt and the pre-cleaning charger 9, controls each process means to carry out an image formation.

In the present invention, control of applying a current to the transfer belt 9 and the pre-cleaning charger 9 is carried out so that the application of current differs between in the image forming region in which an image is formed on a sheet of paper and in a region between images, which region is located between image forming regions. Specifically, applying polarities to the transfer belt 9 and the pre-cleaning charger 9 are switched to each other to reverse polarities between the image forming region and the region between images.

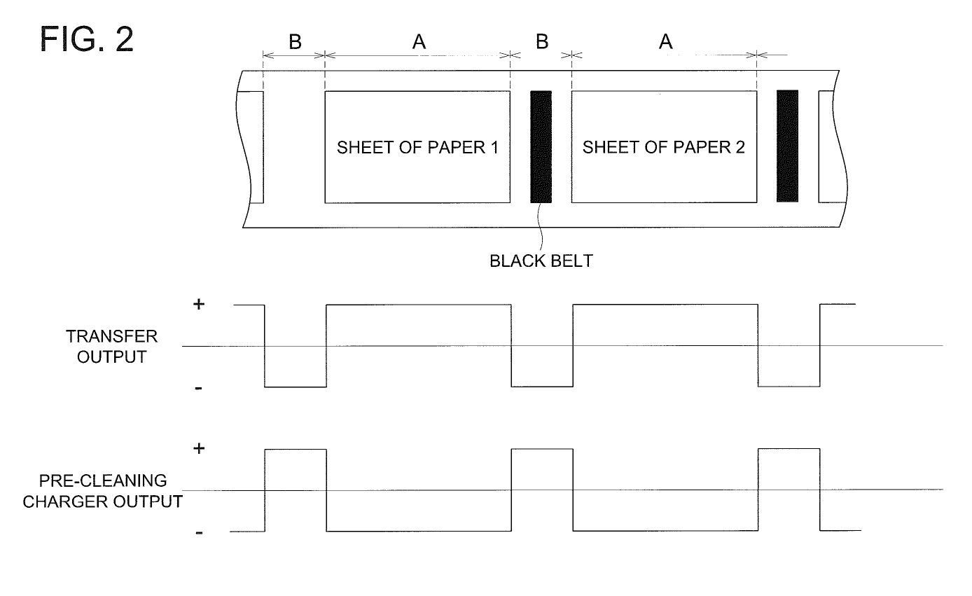

The above switching control is described with reference to FIG. 2. First, as an image forming process, it is assumed that a negatively charged photoreceptor is used, and a development is carrying out with a reverse development system using a negatively charged toner. Since a toner image on the photoreceptor is negatively charged, a positive charge must be applied to the transfer belt to transfer the above toner image to a sheet of paper.

In FIG. 2, the upper row shows a state of an expanded photoreceptor drum 1, and each of regions, in which description for example “sheet of paper 1”, or “sheet of paper 2” is written, indicates the image forming region A. A toner image formed in the image forming region A is transferred to a sheet of paper. The region between the image forming regions A (for example “sheet of paper 1”, or “sheet of paper 2”) indicates the region B between images. In the example of FIG. 2, shown is an example in which a black belt is formed in the region B between images, thereby a residual toner is discharged. Naturally, there may be a case where a toner patch is formed in the region B between images, and the reflection density of the patch is measured, and then, based on the measured value, a control to improve image quality is carried out.

The middle mw of FIG. 2 shows the high-voltage power output to the transfer belt 6, and the lower row of FIG. 2 shows the high-voltage power output to the pre-cleaning charger 9. It should be noted that these figures are for the purpose of explaining polarities of the outputs, and do not show the magnitude of the output. The magnitude of the output will be described later.

In the image forming region A, a positive charge is applied to the transfer belt 6. This is because, as described above, to form an electric field to transfer the negatively charged toner image formed on the photoreceptor drum 1 to a sheet of paper. On the other hand, in the region B between images, a negative charge is applied to the transfer belt 6. This is because to form an electric field to repel the negatively charged toner black belt formed on the photoreceptor drum I so as not to transfer the black belt to the transfer belt 6.

A negative charge is applied to the pre-cleaning charger 9 in the image forming region A. This is because that most of the toner image in the image forming region A is transferred to a sheet of paper, while only a part of the residual toner remains thereon; and the amount of charge of the residual toner is decreased by the transfer belt, or the residual toner is converted to a positive charge. On the other hand, since the toner black belt in the region B between images more firmly adheres to the photoreceptor drum 1 due to the application of a negative charge to the transfer belt 6, a positive charge is applied to the black belt by the pre-cleaning charger 9. With this process, the amount of charge of the toner black belt decreases, thereby the toner can be readily removed by the cleaning device 7.

Although it was explained in the above description that a constant-current power supply was used as the high-voltage power supply which was connected with the transfer belt 6 and the pre-cleaning charger 9, a constant-voltage power supply may be used. Since, in case of using the constant-voltage power supply for the transfer belt 6, the surface potential of the photoreceptor drum is several hundreds volts, a voltage higher than that, for example about 1 kV, is applied to the transfer belt 6. Since the power supply for the pre-cleaning charger 9 is used for the removal of toner on the photoreceptor, the power supply may be a DC power supply on which an AC is superposed.

In case where a constant-current power supply is used for the transfer belt 6, an applied voltage is measured, and in case where a constant-voltage power supply is used for the transfer belt, an applied current is measured, and from each of the above measured values, a resistance value in the transfer region is determined, whereby an output of the pre-cleaning charger 9 may be controlled according to the above resistance value. The “resistance value in the transfer region” means the total resistance value of the system on which electric current flows, such as the transfer belt, and the transfer sheet of paper. Since, in case where the resistance value is high, the electric current is hard to flow under environments such as very low humidity, it may be controlled so as to increases an output of the pre-cleaning charger 9.

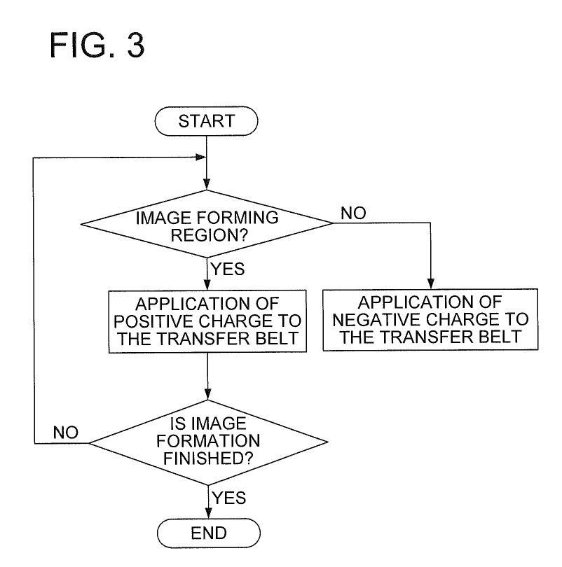

Next, a control routine of charging action to the transfer belt 6 at the transfer section will be described with reference to FIG. 3.

FIG. 3 is a flowchart for explaining the control of charging action to the transfer belt 6 by the controlling section 11.

In response to the beginning of an image forming action, the control routine of charging action in FIG. 3 starts. When the control routine of charging action to the transfer belt 6 by the controlling section 11 starts, the controlling section 11 decides whether or not the region on the photoreceptor 1, which passes through the transfer section of the transfer belt 6, is the image forming region, and in case where it is decided to be the image forming region (Y), the controlling section 11 controls the constant-current power supply 64 so as to apply a positive charge to the transfer belt 6. On the other hand, in case where the controlling section 11 decides that the region on the photoreceptor 1, which passes through the transfer section of the transfer belt 6, is not an image forming region (N), the controlling section 11 controls the constant-current power supply 64 so as to apply a negative charge to the transfer belt 6. After that, when the controlling section 11 judges that the image formation is finished (Y), the controlling section 11 finishes the charging action control routine. When the controlling section 11 judges that the image formation is not finished (N), the controlling section 11 returns the step to the step immediately after the start of the charging action control routine.

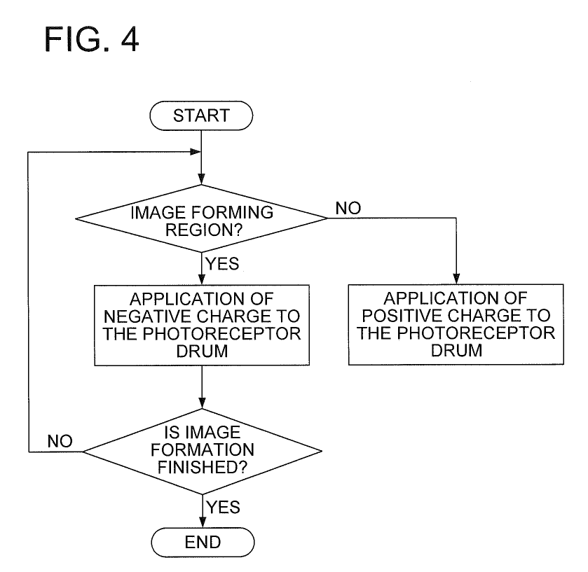

Next, the control routine of charging action to the photoreceptor drum 1 at charging section for blade cleaning will be described with reference to FIG. 4.

FIG. 4 is a flowchart for explaining the control of charging action to the photoreceptor drum 1 by the controlling section 11.

In response to the beginning of an image forming action, the control routine of charging action in FIG. 4 starts. When the control routine of charging action to the photoreceptor drum 1 by the controlling section 11 starts, the controlling section 11 decides whether or not the region on the photoreceptor drum 1, which faces the blade cleaning charger 9, is an image forming region, and in case where it is decided to be the image forming region (Y), the controlling section 11 controls the constant-current power supply 90 so as to apply a negative charge to the photoreceptor drum 1. On the other hand, in case where the controlling section 11 decides that the region on the photoreceptor drum 1, which faces the blade cleaning charger, is not an image forming region (N), the controlling section 11 controls the constant-current power supply 90 so as to apply a negative charge to the photoreceptor drum 1. After that, when the controlling section 11 judges that the image formation is finished (Y), the controlling section 11 finishes the charging action control routine. When the controlling section 11 judges that the image formation is not finished (N), the controlling section 11 returns the step to the step immediately after the start of the charging action control routine.

According to the present embodiments, by a control of polarities of electric current applied to the pre-charge elimination section and the transfer section, the amount of charge of the toner image formed in the region between images on the photoreceptor is decreased to result in reduced burden of the cleaning section, thereby the cleaning can be well achieved.

### EXAMPLES

The above-described invention was carried out using a modified machine of bizhub PRO 1050, manufactured by Konica Minolta Business Technologies Inc. The parameters of the image forming process used for the above implementation are as follows:

Photoreceptor drum: a photosensitive body of 100 mm in diameter

Developers: a polymerized toner of 6 μm and a carrier of 60 μm

Surface potential of photoreceptor drum: −750 V

Development bias: −600 V

Transfer belt (in the image forming region): +80 μA

Transfer belt (in the region between images): −8 μA

PCC (in the image forming region): −20 μA

PCC (in the region between images): +40 μA

Black belt was formed when an average coverage of 60 seconds becomes 3% or less.

Note: The PCC is an abbreviation of a pre-cleaning charger.

Note: The term “coverage” means an occupancy rate of toner on a sheet of paper.

When images, having various sorts of coverage so as to have almost the same conditions as the regular reproductions, were reproduced successively in five hundred thousand pieces, it was found that even the last one of the successive reproductions has no stain or partial image loss on a sheet of paper caused by insufficient cleaning, and residual toner is normally cleaned by a cleaning device. Further, no abnormal wear of a cleaning blade was also generated.

As the transfer section, the transfer belt was described, but a transfer roller may be used. In the above descriptions, a monochrome image forming apparatus was used as an object of the description. However, the present invention can naturally be applied to a color image forming apparatus. In case where a four-cycle system is used as the color image forming method, the present invention may be applied to the transfer belt, which faces the photoreceptor drum, and to the pre-cleaning charger, similarly to the present invention. On the other hand, in case where a tandem system is used, the present invention may be applied to a secondary transfer belt, which transfers a color toner image on an intermediate transfer belt (an image bearing body) to a sheet of paper, and to the pre-cleaning charger, which is arranged for the intermediate transfer belt.

What is claimed is:

1. An image forming apparatus comprising:
a photoreceptor,
a charging section to charge the photoreceptor,
a developing section to develop a latent image formed on the photoreceptor;
a transfer section to transfer the developed image to a transfer sheet using a contact transfer method;
a cleaning section to remove a remaining toner on the photoreceptor;
a control section that performs control so that a toner image is formed in an image forming region, the toner image is transferred to the transfer sheet, and a toner image is formed which is not transferred to the transfer sheet in a region between image forming regions on the photoreceptor; and
a charge elimination section provided between the transfer section and the cleaning section;
wherein the control section controls polarities of electric current applied to the transfer section and the charge elimination section so that the polarities differ between the image forming region and the region between images.

2. The image forming apparatus of claim 1, wherein the transfer section is one of a transfer belt and a transfer roller.

3. The image forming apparatus of claim 1, wherein a power supply for the transfer section is a constant-current power supply and a power supply for the charge elimination section is a constant-current power supply.

4. An image forming apparatus which forms an image and transfers the image to a transfer sheet, the image forming apparatus comprising:
an image carrier;
an image forming section to form a toner image on the image carrier, the image forming section forms a toner image in an image forming region on the image carrier and a toner image that will not be transferred to the transfer sheet in a region between image forming regions on the image carrier;
a transfer section to transfer the toner image on the image carrier to the transfer sheet using a contact transfer method;
a cleaning section to remove a remaining toner on the image carrier;
a pre-cleaning charger provided between the transfer section and the cleaning section facing the image carrier;
a first power supply to supply an electric current to the transfer section;
a second power supply to supply an electric current to the pre-cleaning charger; and
a control section to control the first power supply and the second power supply;
wherein the control section performs control so that supplying polarities by the first power supply and the second power supply are switched between the image forming region and the region between the image forming regions.

5. The image forming apparatus of claim 4, wherein the transfer section is one of a transfer belt and a transfer roller.

6. The image forming apparatus of claim 4, wherein each of the first power supply and the second power supply is a constant-current power supply and a power supply for the pre-charge elimination section is a constant-current power supply.
